(19) United States
(12) Patent Application Publication
(10) Pub. No.: US 2017/0256108 A1
(43) Pub. Date: Sep. 7, 2017

(54) ELECTRONIC EMPLOYEE CARD, PERSONNEL MANAGEMENT SYSTEM AND PERSONNEL MANAGEMENT METHOD

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Gang Ci, Beijing (CN); Hao Wu, Beijing (CN); Na An, Beijing (CN); Baolei Guo, Beijing (CN); Xinfeng Gong, Beijing (CN); Nan Liu, Beijing (CN)

(21) Appl. No.: 15/222,269

(22) Filed: Jul. 28, 2016

(30) Foreign Application Priority Data
Mar. 7, 2016 (CN) 201610127671.3

(51) Int. Cl. G07C 9/00

(52) U.S. Cl. CPC G07C 9/00087; G07C 9/00039; G07C 2009/00095; G07C 2209/02

(57) ABSTRACT

An electronic employee card is disclosed, which includes a control module and a communication module, the control module being configured to be in data communication with a server through the communication module. The control module may control the communication module to transmit the identifying information of an electronic employee card holder captured in real time to the server and obtain a comparing result generated in the server accordingly, which is obtained by comparing the identifying information of the holder captured in real time with personnel identity information prestored in the server; or the control module may obtain the personnel identity information prestored in the server and compare it with the identifying information of the holder captured in real time to generate the comparing result.

### CROSS-REFERENCE TO RELATED APPLICATION

This application claims the benefit of Chinese Patent Application No. 201610127671.3 filed on Mar. 7, 2016 in the State Intellectual Property Office of China, the whole disclosure of which is incorporated herein by reference.

### BACKGROUND

Technical Field

The present invention generally relates to field of wearable device technology, and particularly to an electronic employee card or electronic badge, a personnel management system and a personnel management method.

Description of the Related Art

Currently, employment card is an identity certification for an employee of a company and become an indispensable part of a company. The employment card has a shape of card and is integrated with functions of checking on work attendance, entrance guard card, meal card and the like.

However, the existing employment card cannot meet current requirements of the company as development of society informatization is accelerated. For example, the existing employment card does not have any communication function and exists as an independent card which has to be used in cooperation with a terminal device and thus lacks convenience. In prior arts, a fingerprint attendance machine may be used for checking on work attendance. However, it is required to mount a special fingerprint attendance machine. Fingerprint attendance will be made by all employees in a company through the same fingerprint attendance machine, which might cause the fingerprint attendance machine to be failed.

Therefore, it is needed to provide a new type of electronic employee card to meet requirements of society informatization and intelligence.

### SUMMARY

Embodiments of the present invention aim to provide an electronic employee card, a personnel management system and a personnel management method, for solving the problem in prior arts that the electronic employee card has no communication function.

As an aspect, there is provided an electronic employee card comprising: a control module and a communication module that is coupled to the control module, the control module being configured to be in data communication with a server through the communication module; and

an acquisition module coupled to the control module and configured to acquire identifying information of a holder of the electronic employee card in real time;

wherein the control module is configured to control the communication module to transmit the identifying information of the holder of the electronic employee card acquired in real time to the server and obtain a comparing result generated in the server, which is obtained by comparing the identifying information of the holder of the electronic employee card acquired in real time with personnel identity information prestored in the server; or

the control module is configured to obtain the prestored personnel identity information from the server and compare it with the identifying information of the holder of the electronic employee card acquired in real time to generate a comparing result.

In an embodiment, the personnel identity information comprises identifying information that is in an one-to-one correspondence with the personnel identity information, and the control module is configured to compare the identifying information acquired in real time with identifying information of the personnel identity information obtained from the server and determine that the comparing result is a matched comparing result if the acquired identifying information is consistent with the obtained identifying information.

In an embodiment, the identifying information of the holder of the electronic employee card comprises fingerprint information.

In an embodiment, the electronic employee card further comprises a display module configured to display the personnel identity information received by the communication module, under the control of the control module.

In an embodiment, the electronic employee card further comprises a memory module coupled to the control module and configured to store the personnel identity information received by the communication module, wherein the control module is configured to load the personnel identity information stored in the memory module to the display module.

In an embodiment, the server is configured to transmit information of successfully punching a time clock by the holder of the electronic employee card and the personnel identity information to the communication module when the sever obtains the matched comparing result; or

the control module is configured to transmit, via the communication module, the matched comparing result to the server when the control module obtains the matched comparing result, and the server is configured to transmit the information of successfully punching a time clock by the holder of the electronic employee card to the communication module according to the received matched comparing result; and

the control module is configured to transmit a first display instruction to the display module after the communication module receives the information of successfully punching a time clock by the holder of the electronic employee card, so as to control the display module to display the personnel identity information.

In an embodiment, the server is configured to transmit information of unsuccessfully punching a time clock by the holder of the electronic employee card to the communication module when the server obtains an unmatched comparing result, or

the control module is configured to transmit, via the communication module, the unmatched comparing result to the server when the control module obtains the unmatched comparing result, and the server is configured to transmit the information of unsuccessfully punching a time clock by the holder of the electronic employee card to the communication module according to the unmatched comparing result received; and

the control module is further configured to transmit a second display instruction to the display module after the communication module receives the information of unsuccessfully punching a time clock by the holder of the electronic employee card, so as to control the display module to display the information of unsuccessfully punching a time clock by the holder of the electronic employee card.

In an embodiment, the control module is further configured to control the display module to display options to be selected by the holder after transmitting the display instruction to the display module;

the electronic employee card further comprises an input module coupled to the control module and configured to input an option selected by the holder to the control module; and

the control module is further configured to control the display module to display the personnel identity information when receiving an option that it is determined to display the personnel identity information.

In an embodiment, the input module comprises a keyboard input module and/or a touch screen input module.

In an embodiment, the control module is further configured to get data communication with the server through the communication module, to obtain at least one of the followings from the server: meal card information, entrance guard information, notification information.

In an embodiment, the communication module comprises a wireless communication unit.

In an embodiment, the electronic employee card further comprises:

a wireless signal detecting module configured to detect a wireless signal in a surrounding environment and transmit a trigger signal to the control module when detecting a wireless signal that matches with a preset wireless signal address, and

the control module is further configured to control the communication module to establish a data communication with the server after receiving the trigger signal.

In an embodiment, the electronic employee card further comprises a power-supply module configured to supply power to the electronic employee card.

In an embodiment, the power-supply module comprises a battery and a power management unit coupled to each other, and the power management unit is configured to transform electrical energy from the battery to electrical energy that is required for the control module.

In an embodiment, the control module is further configured to receive, through the communication module, a notification transmitted by the server and control the display module to display the notification.

In an embodiment, the control module is configured to receive, through the communication module, a notification transmitted by the server and control the display module to display the notification; and

the control module is further configured to transmit the notification to and store the notification in the memory module.

As an another aspect, there is provided a personnel management system, comprising the electronic employee card as mentioned above and a server, wherein the server prestores therein the personnel identity information corresponding to the holder of the electronic employee card.

As a still aspect, there is provided a personnel management method, comprises:

comparing the identifying information of the holder of the electronic employee card acquired in real time with the prestored personnel identity information;

determining successfully checking on work attendance when the personnel identity information matches with the identifying information of the holder of the electronic employee card; and

determining unsuccessfully checking on work attendance when the personnel identity information does not match with the identifying information of the holder of the electronic employee card.

In an embodiment, the personnel management method further includes:

determining the holder of the electronic employee card leaves earlier than one should if the identifying information of the holder of the electronic employee card is not acquired in a first preset period of time and a beginning time point of the first preset period of time is earlier than an ending time point of a second preset period of time;

wherein the first period of time is smaller than the second period of time.

### BRIEF DESCRIPTION OF THE DRAWINGS

The accompanying drawings are provided for further understanding the present invention and composes of a part of the description for interpreting the present invention in conjunction with the below embodiments, instead of limiting the present invention. in the drawings:

FIG. 1 is a basic structural view of an electronic employee card according to an embodiment of the present invention;

FIG. 2 is a structural view of an electronic employee card with an acquire function according to an embodiment of the present invention;

FIG. 3 is a structural view of an electronic employee card with a display function according to an embodiment of the present invention;

FIG. 4 is a structural view of an electronic employee card with a memory function according to an embodiment of the present invention;

FIG. 5 is a structural view of an electronic employee card with an input function according to an embodiment of the present invention;

FIG. 6 is a structural view of an electronic employee card with a wireless signal detecting function according to an embodiment of the present invention;

FIG. 7 is a structural view of an electronic employee card with a power-supply module according to an embodiment of the present invention;

FIG. 8 is a specific structural view of the power-supply module shown in FIG. 7 according to an embodiment of the present invention;

FIG. 9 is an overall structural view of an electronic employee card according to an embodiment of the present invention;

FIG. 10 is a block view showing a personnel management method according to an embodiment of the present invention;

FIG. 11 is flow chart of implementing functions of the electronic employee card according to an embodiment of the present invention; and

FIG. 12 is a schematic diagram showing appearance of an electronic employee card according to an embodiment of the present invention.

In the drawings, reference numbers are listed as below:

10—electronic employee card; 100—control module; 101—communication module; 102—capturing module; 103—memory module; 104—display module; 105—input module; 106—wireless signal detecting module; 107—power-supply module; 1071—battery; 1072—power management unit; 201—hanging ring; 202—fingerprint identifying device; 203—OK key; 204—function key; 205—display screen

### DETAILED DESCRIPTION OF THE EMBODIMENTS

Embodiments of the present invention will be described hereinafter in detail and completely with reference to the attached drawings. Obviously, the embodiments illustrated in these drawings are instructed to illustrate and interpret the present invention, instead of limitation of the present invention.

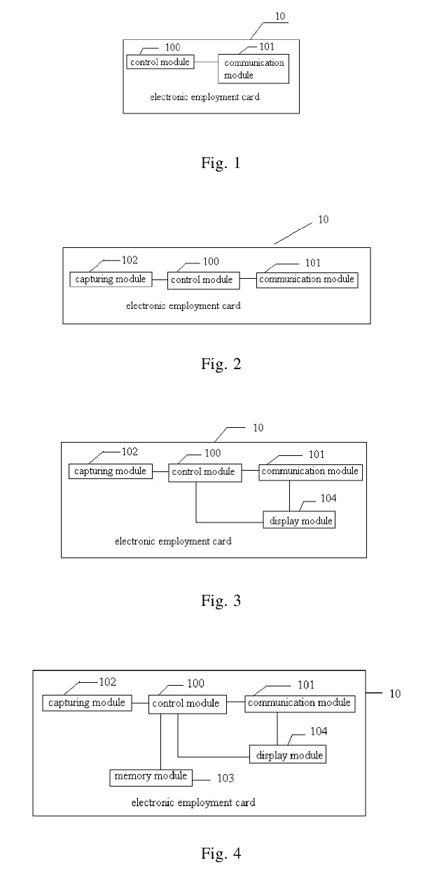

As an aspect of the present invention, there is provided an electronic employee card 10, as shown in FIG. 1, which specifically includes a control module 100 and a communication module 101 coupled to the control module 100. The control module 100 is configured to be in data communication with a server through the communication module 10. Personnel identity information is prestored in the server.

In an embodiment of the present invention, the control module 100 may control the communication module 101 to transmit the identifying information of an electronic employee card holder acquired in real time to the server. After receiving the identifying information, the server compares the identifying information with the personnel identity information prestored in the server, to generate a comparing result.

In an another embodiment of the present invention, the control module may obtain the prestored personnel identity information in the server and compare it with the identifying information of an electronic employee card holder acquired in real time to generate the comparing result.

Specifically, the electronic employee card 10 is in data communication with the server, mainly via the control module 100 and the communication module 101 in the card. The control module 100 is mainly provided with responsibility for controlling normal operation of the electronic employee card. In an embodiment, it controls, such as, a data communication between the communication module 101 and the server. The communication module 101 is implemented for data transmission. In an embodiment, the communication module 101 performs the data transmission when the electronic employee card 10 is in data communication with the server. The server that is configured to be in data communication with the electronic employee card 10 may prestore some data information, for example, the personnel identity information of the electronic employee card holder, and may prestore the personnel identity information of all of holders of electronic employee cards, which may be in data communication with the server. For example, a server of a company may store personnel identity information of all staff in the company. For example, when an electronic employee card holder enter a certain region of a company, the communication module 101 of the electronic employee card 10 performs a data communication with the server of the company, such that the server of the company may automatically validate the electronic employee card and its holder having entered the company from the exterior, such as being on duty in the morning, so as to achieve checking on work attendance.

It will be appreciated that the personnel identity information includes person data information including personnel identity information of the electronic employee card holder, such as name, gender, person photo, duty job and the like. The personnel identity information of each user is in a one-to-one correspondence with respective identifying information. For example, a company includes ten employees and each of them has his/her respective personnel identity information that is in a one-to-one correspondence with respective identifying information.

In another embodiment of the present invention, the control module 100 may obtain prestored personnel identity information of an electronic employee card holder from the server while capturing in real time identifying information of the electronic employee card holder, when it is in data communication with a server via the communication module 101. After acquiring the prestored person information of the electronic employee card holder, the control module 100 may compare the prestored personnel identity information with the identifying information acquired in real time and generate a comparing result.

The control module and the communication module are provided in the electronic employee card provided according to embodiments of the present invention, such that the control module may be in data communication with an exterior server via the communication module and may control the electronic employee card to acquire in real time some identifying information, so as to compare the prestored personnel identity information with the identifying information acquired in real time to finally determine whether or not the person identity of the electronic employee card holder is valid. If the identifying information matches with the personnel identity information, successfully checking on work attendance is determined. If the personnel identity information does not match with the identifying information, unsuccessfully checking on work attendance is determined.

From this, the electronic employee card enables checking on work attendance of its holder without providing other apparatus or device for cooperation and thus may achieve advantages of flexibility and convenience.

In the present invention, there is no specific requirement on the comparison between the personnel identity information and the identifying information. For example, as an example, the personnel identity information may include the identifying information that is in an one-to-one correspondence with the personnel identity information. The control module 100 may compare the identifying information acquired in real time with the identifying information of the personnel identity information obtained from the server, and generate a matched comparing result when they are in consistent with each other.

In order to achieve a function of capturing in real time the identifying information of electronic employee card holder, as shown in FIG. 2, the electronic employee card 10 may further include a capturing module 102 coupled to the control module 100, which is configured to acquire in real time the identifying information of an electronic employee card holder under control of the control module 100. In the embodiment, the identifying information may be obtained through the electronic employee card, without providing other common identity acquiring apparatus or device. One electronic employee card is only used by one person, which may extend service life of the electronic employee card and improve accuracy of checking on work attendance.

In an embodiment, the identifying information of the electronic employee card holder may include fingerprint information of the electronic employee card holder. When having acquired the identifying information of the electronic employee card holder in real time, i.e., obtained in real time the fingerprint information of the electronic employee card holder, the capturing module 102 transmits the obtained fingerprint information of the electronic employee card holder to the control module 100. As the prestored personnel identity information in the server solely corresponds to the identifying information matched with it (i.e., the data information that solely matches with the fingerprint information of the electronic employee card holder), the control module 100 compares the fingerprint information acquired in real time with the prestored personnel identity information in the server and determines whether or not the person identity of the electronic employee card holder that shows work attendance by using the electronic employee card 10 is valid according to the comparing result. By using the electronic employee card, the electronic employee card holder may show work attendance flexibly and conveniently.

It is noted that the present invention is not limited to the fingerprint information as the identifying information, but may be implemented by using facial features or iris pattern as the identifying information.

In another embodiment of the present invention, the electronic employee card 10 may further include a display module 104, as shown in FIG. 3. The display module 104 may display the personnel identity information received by the communication module 101 under control of the control module 100. The electronic employee card 10 according to the embodiment may give an explicit way to the electronic employee card holder to know whether or not he/she has been checked on work attendance successfully.

In an still another embodiment of the present invention, as shown in FIG. 4, the electronic employee card 10 may further include a memory module 103 that is coupled to the control module 100 and configured to store the personnel identity information received by the communication module 101, such that the electronic employee card 10 has a memory function, thereby further improving use of the electronic employee card by its holder. In this instance, the control module 100 may load the personnel identity information stored in the memory module 103 onto the display module 104 such that the display module 104 may display the personnel identity information. The storage of the personnel identity information of the electronic employee card holder in the electronic employee card 10 is convenient for directly loading the personnel identity information from the memory module 103 when the control module 100 determines that the electronic employee card holder has been checked on work attendance successfully, thereby increasing operation speed of the electronic employee card. It will be understood that the memory module is not necessary for the electronic employee card.

The below description is made for how the control module 100 controls the display module 104 to display person information.

As described in the above content, there may be two approaches for generating the comparing result, one is to generate the comparing result in the server and the other is to generate the comparing result in the control module 100.

In the first approach, when the comparing result obtained by the server is matched comparing result, the server may transmit information about successfully checking on work attendance of the electronic employee card holder and the personnel identity information to the communication module 101.

In the second approach, when the comparing result obtained by the control module is a matched comparing result, the control module 100 may transmit the matched comparing result to the server through the communication module 101; and the server may transmit information about successfully checking on work attendance of the electronic employee card holder to the communication module 101 according to the received matched comparing result.

No matter which one of the first and second approaches is applied, the control module 100 could transmit a first instruction to the display module after receiving the information about successfully checking on work attendance of the electronic employee card holder, to control the display module 104 to display the personnel identity information.

In the first approach of the present invention, when the server obtains an unmatched comparing result, the server may transmit the information about unsuccessfully checking on work attendance of the electronic employee card holder to the communication module 101.

In the second approach of the present invention, when the control module 100 obtains unmatched comparing result, the control module 100 may transmit the unsuccessfully matched comparing result to the server through the communication module 101 and the server may transmit the information about unsuccessfully checking on work attendance of the electronic employee card holder to the communication module 101 according to the comparing result.

Accordingly, the control module 100 may transmit a second display instruction to the display module 104 after receiving the information about unsuccessfully checking on work attendance of the electronic employee card holder by the communication module, to control the display module 104 to display the information about unsuccessfully checking on work attendance.

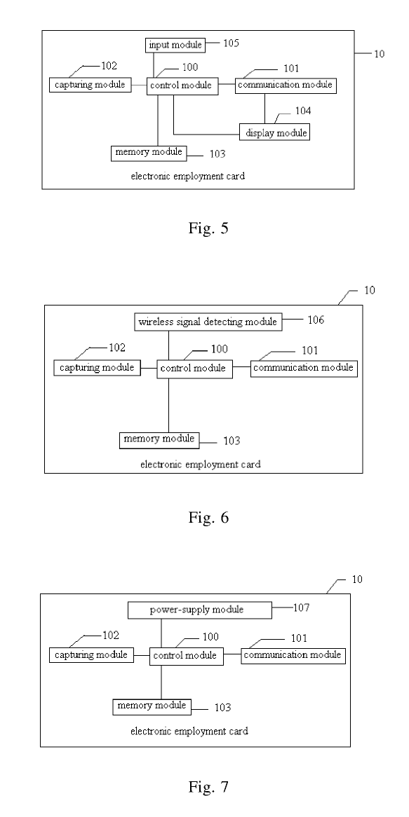

In a still further embodiment, as shown in FIG. 5, based on the structure shown in FIG. 4, the electronic employee card 10 may further include an input module 105 that is coupled to the control module 100 and configured to input a selected result by the user to the control module 100. In some cases, after transmitting the display instruction to the display module 104, the control module 100 may further control the display module 104 to display option information for the user. For example, option information, such as “confirm”, “cancel”, “yes”, “no”, or the like, may be displayed for the user by the display module 104, and the selected option may be inputted via the input module 105 in the embodiment, which is convenient for selection of user. It will be appreciated that the above structure may not include the capturing module 102 and/or the memory module 103, and the electronic employee card 10 may further include the input module 105 that is coupled to the control module 100 and configured to input a selected result by the user to the control module 100. For example, when the display module 104 receives the display instruction from the control module 100 and thus displays the personnel identity information of the user together with the option information that provides option for the user, such as “Is the personnel identity information right” and its option of “yes” and “no”. After viewing the displayed personnel identity information, the user may select the option of “yes” by the input module 105 if the displayed personnel identity information matches the personnel identity information of the user himself/herself, i.e., the displayed personnel identity information is right. After receiving the option information of “yes”, the control module 100 may control the display module 104 to display the personnel identity information to the user.

In the above embodiment, after user inputs the option of “yes”, i.e., confirms the displayed personnel identity information to be right, the display module 104 may further display “Confirm the displayed personnel identity information” and corresponding options of “confirm” and “cancel”, and the user may select “confirm” by the input module 105. The control module may control the display module 104 to display the personnel identity information to the user when receiving the option of “confirm”.

In an embodiment, the input module 105 may include a keyboard input module 1051 and/or a touch screen input module 1052. In an example, the keyboard input module 1051 may be of key input type and the touch screen input module 1052 may be of touch screen input type. It will be appreciated that the electronic employee card 10 may be provided with a combination of the keyboard input module 1051 and the touch screen input module 1052 as the input module 105, or, may be only provided with the keyboard input module 1051 or the touch screen input module 1052 as the input module 105.

In an embodiment, in addition to the above functions, the control module 100 may further be configured to obtain some data information from the server when being in data communication with the server through the communication module 101, in which the data information may include at least one of the following: meal card data information, entrance guard card data information, and notification data information.

It will be appreciated that, in case that the electronic employee card 10 functions as a meal card, the control module 100 may obtain data information about functions of the meal card from the server. For example, information about a balance of the meal card may be obtained from the server. In case that the electronic employee card 10 functions as an entrance guard card, the control module 100 may obtain data information about functions of the entrance guard card from the server. For example, data information of the entrance guard card prestored in the server may be obtained from the server and be compared with that acquired in real time. If the comparison result shows that obtained data information is consistent with the prestored data information, a gate will be opened; otherwise, the gate will not be opened. When the electronic employee card 10 functions as a notification receiver configured to obtain notification data information, such as, internal notification of the company, the notification may be stored in the server and the user holding the electronic employee card 10 may obtain the notification from the server. Specifically, after the electronic employee card holder chooses the notification function, the control module 100 of the electronic employee card 10 may start the notification function to obtain the notification information from the server through the communication module 101. After that, the control module 100 may control the display module 104 to display the notification information. Then, the electronic employee card holder may see the notification information.

It is noted for the above functions of the electronic employee card 10 that the data information associated with the functions may be retained on the display module 104 for a fixed period of time when the data information is displayed by the display module 104. When the data information associated with the functions has been retained beyond the fixed period of time and no operation is performed to the displayed content on the display module 104, the control module 100 will control the display module 104 to display the personnel identity information. It will be appreciated that the display screen of the display module 104 may display the personnel identity information of the electronic employee card holder, such as name, gender, duty job, photo, etc., when a display main interface of the display module 104 of the electronic employee card 10 is accessed and no operation is entered to the electronic employee card 10. The electronic employee card 10 may come into stand-by state if no operation is entered for a long time, in order to save electrical power.

In an embodiment, the communication module 101 may include a wireless communication unit so as to facilitate communication between the electronic employee card 10 and the server. The control module 100 may be in data communication with the server through the wireless communication unit.

In an embodiment, FIG. 6 illustrates a structural schematic view of an electronic employee card 10 including the capturing module 102 and the memory module 103. It will be understood that the card may further include the display module 104 and the input module 105 as mentioned above. It will be also understood that the card may not include the capturing module 102 and/or may not include the memory module 103. The electronic employee card 10 may further include a wireless signal detecting module 106 that is coupled to the communication module 101 and is configured to detect wireless signal address around the electronic employee card. The wireless signal detecting module 106 may transmit a trigger signal to the control module 100 when the detected wireless signal address matches with a preset wireless signal address. Then, the control module 100 may control the communication module 100 to establish a data communication with the server after receiving the trigger signal.

As appreciated, when an electronic employee card holder carrying the electronic employee card 10 enters a publish environment with, the wireless signal detecting module 106 of the electronic employee card 10 may firstly detect wireless signal address in the environment around the electronic employee card 10. When a wireless network signal matched with the electronic employee card 10 is found, the electronic employee card 10 may be connected to the wireless network through the wireless signal communication unit. For example, when an employee of a company holding an electronic employee card 10 enters the company, the wireless signal detecting module 106 of the electronic employee card 10 may detect an internal wireless signal address of the company. As the wireless signal detecting module 106 prestores therein the wireless signal address of the company, the wireless signal detecting module 106 may be automatically connected to the wireless network of the company when detecting the wireless signal address of the company, thereby the electronic employee card 10 may be in data communication with the server of the company through the data communication unit.

In an embodiment of the invention, the electronic employee card 10 may include, such as, the control module 100 and the communication module 101, in which the communication module 101 functions to detect the wireless signal and its address in the environment around the electronic employee card.

As an embodiment of the present invention, as shown in FIG. 7, it will be appreciated that the structure in FIG. 7 may include the display module 104, the input module 105 and the wireless signal detecting module 106 mentioned in previous embodiments. It will be further appreciated that the structure in FIG. 7 may not include the capturing module 102 and/or may not include the memory module 103. The electronic employee card 10 may further include a power-supply module 107 configured to supply power to the electronic employee card such that electronic employee card may normally work as its holder moves.

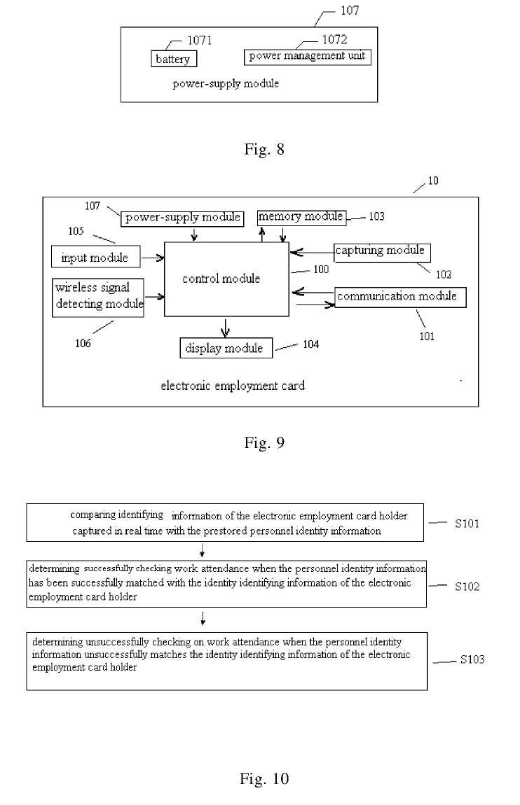

As shown in FIG. 8, in order to ensure normal power supply, the power-supply module 107 may include a battery 1071 and a power management unit 1072 coupled to each other. The power management unit 1072 is mainly configured to transform the electrical energy from the battery 1071 to electrical power for operation of the control module 100.

It will be appreciated that the battery may be a lithium battery and may be charged when being in a low power.

As an example, the control module 100 may receive notification from the server through the communication module 101 and control the display module 104 to display the notification. As mentioned above, the control module 100 may obtain data information of starting notification function from the server through the communication module 101. It will be understood that the control module 100 may receive a notification issued by the server through the communication module 101 after acquiring the data information of starting notification function from the server, and display the content of the notification through the display module 104. For example, an employee of a company holding the electronic employee card 10 may establish a data communication with a server of the company. When the company has a notification to be issued, the notification will be stored in the server and the employee may obtain the notification from the server through the electronic employee card 10 that he/she holds. In this way, the employee in the company may conveniently receive the notification issued by the company in time.

In an embodiment, as mentioned above, the electronic employee card 10 may further include the memory module 103, such that the control module 100 may enable the notification obtained from the server to be stored in the memory module 103. In this way, it is convenient for the electronic employee card holder to look up the notification that has been received in the case that the electronic employee card is not in connection with the server.

In an embodiment of the present invention, as shown in FIG. 9, it shows a schematic structural view of an electronic employee card 10 including the above various modules. It will be appreciated that FIG. 9 is just a schematic structural view, instead of an actual connection relationship view, of the electronic employee card 10 including the above various modules. Further, it will be appreciated that FIG. 9 just shows an embodiment of the present invention and some of the modules therein are not indispensable. The electronic employee card 10 may include the control module 100, the communication module 101, the capturing module 102, the memory module 103, the display module 104, the input module 105, the wireless signal detecting module 106 and the power-supply module 107. For example, an employee of a company holds the electronic employee card 10 according to the embodiment of the present invention, and the electronic employee card 10 may operate as below:

When the employee holding the electronic employee card 10 enters the company, the wireless signal detecting module 106 of the electronic employee card 10 begins to detect a wireless network signal in the environment of the company. When the wireless network signal having a wireless network signal address that matches with the electronic employee card 10 is detected, the electronic employee card 10 performs a data communication with the wireless network of the company through the communication module 101. It will be understood here that the communication module 101 may be connected with the wireless network of the company in wireless communication manner. When the electronic employee card 10 is in connection with the wireless network of the company, the control module 100 thereof may obtain some data information from the server of the company through the communication module 101, for example, obtain the personnel identity information of the employee stored in the server of the company. If the employee selects function of checking on work attendance on the display module 104 of the electronic employee card through the input module 105, the capturing module 102 of the electronic employee card 10 will acquire the identifying information of the employee in real time under control of the control module 100. For example, the capturing module 102 may be a fingerprint identifying device and the identifying information acquired may be fingerprint information of the employee. In this instance, the control module 100 may compare the identifying information acquired by the capturing module 102 with the personnel identity information obtained from the server. If they match with each other, the employee is determined to be successfully checked on work attendance, and the control module 100 in the electronic employee card 10 may load the prestored personnel identity information in the memory module 103 onto the display module 104 for displaying. The personnel identity information stored in the memory module 103 may be the same as the personnel identity information obtained from the server of the company. During the entire operation process, the power-supply module 107 supplies power to various functional modules for normal operations. Of course, the employee may also choose other functions of the electronic employee card 10 through the display module 104, such as meal card function, entrance guard function, information acquiring function, or the like. When performing these functions, the electronic employee card 10 may work in a similar manner as the operation for the function of checking on work attendance, except that the identifying information may be not acquired by the capturing module 102 when performing the notification acquiring function. It will be understood that the electronic employee card 10 could not get in connection to the wireless network of the company and thus the functions of checking on work attendance, meal card, entrance guard card, notification and the related functions would not be achieved if the employee carrying the electronic employee card 10 leaves the company.

In another embodiment of the present invention, the electronic employee card 10 may further have extensibility, i.e., it may have a function extending interface such that the electronic employee card 10 may be extended to have another function as required based on the mentioned functions of the electronic employee card 10, if the another function that is not mentioned above is needed to be added.

The electronic employee card provided by the embodiments of the present invention may be provided with the control module, the communication module, the display module, the memory module, the acquire module, and the input module, etc., such that the control module may be achieve data communication with the exterior server through the communication module and control the electronic employee card to acquire some identifying information in real time, and finally determine whether or not the identity of the electronic employee card holder is true or valid by comparing the identifying information acquired in real time with the prestored personnel identity information. The electronic employee card provided by the embodiments of the present invention may further display the personnel identity information by the display module, store some data information and notification, etc. in the memory module, and/or choose various functions of the electronic employee card through the input module, such as the functions of checking on work attendance, entrance guard, meal card, notification receipt and the like. The electronic employee card provided by the embodiments of the present invention may implement various functions for the electronic employee card holder and has advantages such as flexible and nimble use.

As another aspect of the present invention, there is provided a personnel management system, comprising the electronic employee card as shown in FIG. 9 that can implement the mentioned various functions and the server that may be in data communication with the electronic employee card. The server prestores the personnel identity information corresponding to the electronic employee card holder before being in data communication with the electronic employee card. It will be appreciated that the server may perform data communication with a plurality of electronic employee cards and thus may store personnel identity information of a plurality of electronic employee card holders of the electronic employee cards. For example, a server of a company may store personnel identity information of all employees of the company and the electronic employee card of each of the employees may perform data communication with the server.

As a still another aspect of the present invention, there is provided a personnel management method using the above mentioned electronic employee card, as shown in FIG. 10, the personnel management method may include:

Step S101: comparing the identifying information of the electronic employee card holder acquired in real time with the prestored personnel identity information.

Specifically, it is known from the above description that the personnel management system may include the electronic employee card having various functions and the server that can perform date communication with the electronic employee card. The electronic employee card may include the control module and the communication module, such that the control module of the electronic employee card in the personnel management system may be in data communication with the server through the communication module to obtain the prestored personnel identity information in the server, and then compare the identifying information of the electronic employee card holder acquired in real time with the personnel identity information.

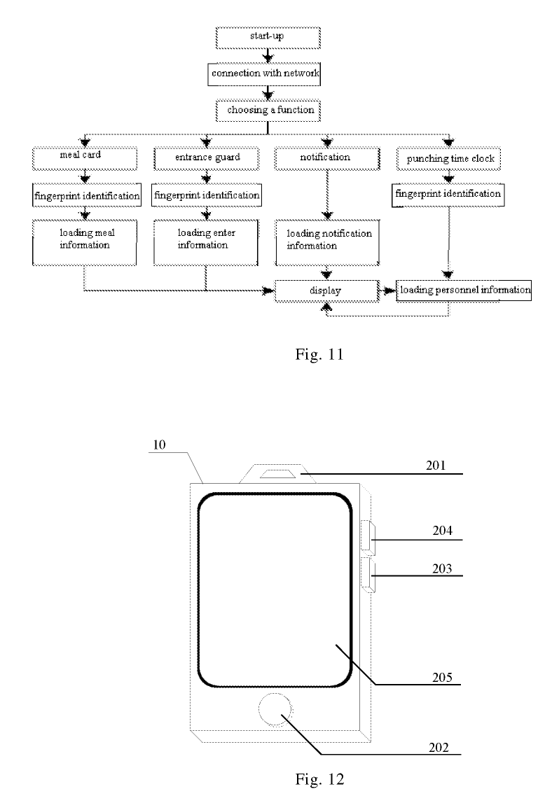

In an embodiment, referring to FIG. 11, FIG. 11 illustrates an operation flow view of the electronic employee card. There is provided an example of an employee holding the electronic employee card, in which the electronic employee card may have the modules and functions as mentioned above. When the electronic employee card is started up and the employee holding the electronic employee card enters the company, the wireless signal detecting module of the electronic employee card may detect the network signal address of the company so as to be in data communication between the electronic employee card and the server of the company through the wireless communication unit. After the data communication between the electronic employee card and the server of the company has been established, the employee holding the electronic employee card may choose a function on the display interface of the electronic employee card, for example, choose the function of checking on work attendance. The identifying information of the employee holding the electronic employee card may be acquired through the capturing module of the electronic employee card. In an embodiment, the identifying information of the employee holding the electronic employee card may be acquired through a fingerprint identifying device, as shown in FIG. 12, which is a schematic diagram showing appearance of an example of the electronic employee card. As shown in the Figure, the capturing module may comprise the fingerprint identifying device 202, the display module may comprise a display screen 205 and the input module may comprise a function key 204 and an OK key 203. In order to facilitate the employee to carry the electronic employee card, the structure of the electronic employee card is provided with a hanging ring 201. The electronic employee card 10 with the fingerprint identifying device 202 may firstly acquire the fingerprint information of the electronic employee card holder, then compare it with the prestored fingerprint information of the electronic employee card 10 obtained from the server, and determine whether or not the electronic employee card 10 matches with the identity of the electronic employee card holder based on the comparing result.

It will be understood that the identity of the electronic employee card holder is needed to be validated, which is similar to the situation of implementing the function of checking on work attendance, in situation that the electronic employee card holder chooses the function of meal card through the display interface of the electronic employee card. Specifically, similar to implementing the function of checking on work attendance, the fingerprint information may be acquired and, after having successfully acquired the fingerprint information, the information related to meal card may be displayed in the display module. The process may be referred to the above mentioned description about the functions of the electronic employee card and is not repeated here. When the function of entrance guard is chose by the electronic employee card holder through the display interface of the electronic employee card, his/her identity is also needed to be validated, similar to the process of implementing the function of checking on work attendance. If the fingerprint information is successfully validated, information of pass permission and the like may be displayed through the display module and is not described in detailed. It will be understood that other validation manners may be used, such as password validation, face identification, sound validation, and the like. In various embodiments, the electronic employee card may be provided with a plurality of validation manners, including face identification, sound validation, password validation, other validation manners and a combination thereof. If the electronic employee card holder chooses the function of notification through the display interface of the electronic employee card, that is, chooses the function of acquiring some notification information from the server of the company through the electronic employee card, he/she may choose notification information directly without identity validation and may watch the notification information through the display module of the electronic employee card.

It will be noted that, as the electronic employee card includes the input module and the input module may include a keyboard input, including some functional keys and OK key, the electronic employee card holder may choose a desired function through the functional key of the electronic employee card and confirm the chose function through the OK key.

The personnel management method may further include step S102: determining successfully checking on work attendance when the personnel identity information has been matched with the identifying information of the electronic employee card holder.

Specifically, in the above mentioned personnel management system, it is determined whether or not the identifying information of the electronic employee card holder acquired in real time by the electronic employee card successfully matches with the personnel identity information. If the identifying information of the electronic employee card holder acquired in real time by the electronic employee card successfully matches with the personnel identity information, it is determined that the identity of the electronic employee card holder is successfully validated. In an embodiment, when the electronic employee card holder is checked on work attendance in the company, he/she may be successfully checked on work attendance if it is determined the electronic employee card holder's identity is successfully validated. After successfully checking on work attendance, the display interface of the electronic employee card may display some personnel identity information of the electronic employee card holder, for example, display name, gender, person photo, duty job and the like of the electronic employee card holder. However, this is not necessary. Alternatively, after successfully checking on work attendance, the display interface of the electronic employee card displays “success”, or displays a signal, such as a light green lighting.

The personnel management method may further include step S103: determining unsuccessfully checking on work attendance when the personnel identity information fails to match with the identifying information of the electronic employee card holder.

Specifically, in the above mentioned personnel management system, it is determined whether or not the identifying information of the electronic employee card holder acquired in real time by the electronic employee card matches with the personnel identity information, and then validation of the identity of the electronic employee card holder is determined to be failed if the identifying information of the electronic employee card holder acquired in real time by the electronic employee card fails to match with the personnel identity information. In an embodiment, when the function of checking on work attendance is performed in the company by the electronic employee card holder, the check on work attendance of the electronic employee card holder is failed if validation of the identity of the electronic employee card holder is determined to be failted. For example, when validation is failed, the display interface of the electronic employee card may display “failure”, or display a signal of light red lighting. The electronic employee card holder may be re-validated or change a validation way.

The embodiments of the present invention provide a personnel management method to achieve management functions of checking on work attendance and the like of the employees in the company by acquiring information carried by the electronic employee card and validating identity information. The personnel management method may be suitable for development of society informatization and intelligence and may have advantages including flexible convenience for personnel management.

As a preferable embodiment, the personnel management method may manage an employee who leaving earlier than one should in duty time so as to achieve a more comprehensive management function on checking on work attendance of the employee. Specifically, the electronic employee card holder is determined to leave earlier than one should if the capturing module of the electronic employee card does not acquire the identifying information of the electronic employee card holder in a first preset period of time and a beginning time of the first preset period of time is earlier than an end time of a second preset period of time, wherein the first preset period of time is shorter than the second preset period of time.

In an embodiment, as an example of one-day work of an employee in the company, if an on-duty time of the company is from 9 a.m. to 5 p.m., the period of time of on-duty may be the second period of time. As the electronic employee card loses contact with the server of the company when the electronic employee card holder leaves the company, the server may determine the electronic employee card holder to be in off-duty state. When a time when the electronic employee card acquires the identifying information of the electronic employee card holder is before 9 a.m. and after 5 p.m., the electronic employee card holder is determined to be in a normal checking on work attendance; if the electronic employee card holder leaves the company at a time between 9 a.m. and 5 p.m., i.e., lose contact with the server, and return to the company before 5 p.m. and re-connect to the server, the electronic employee card holder may continue to check on work attendance; if the electronic employee card holder leaves the company at a time between 9 a.m. and 5 p.m. and does not return the company before 5 p.m., and a period of time out of the company is longer than a specified period of time before 5 p.m. (for example, in the case that the specified period of time for out of the company is half an hour, the electronic employee card holder is determined to leave earlier than one should if he/she leaves the company at 4 p.m. and does not return the company before 5 p.m.; and he/she is determined to continue to be checked on work attendance if returning at or before 4:30 p.m.).

Obviously, it is obvious to modify and change the embodiments of the present invention without departing from inspirit and scope of the present invention. These modification and change to the embodiments of the present invention shall be covered in the scope of the present invention if they fall within the scope of the claims and equivalents.

1. An electronic employee card, comprising:
a control module and a communication module that is coupled to the control module, the control module being configured to be in data communication with a server through the communication module; and
an acquisition module coupled to the control module and configured to acquire identifying information of a holder of the electronic employee card in real time;
wherein the control module is configured to control the communication module to transmit the identifying information of the holder of the electronic employee card acquired in real time to the server and obtain a comparing result generated in the server, which is obtained by comparing the identifying information of the holder of the electronic employee card acquired in real time with personnel identity information prestored in the server; or
the control module is configured to obtain the prestored personnel identity information from the server and compare it with the identifying information of the holder of the electronic employee card acquired in real time to generate a comparing result.

2. The electronic employee card as claimed in claim 1, wherein the personnel identity information comprises identifying information that is in an one-to-one correspondence with the personnel identity information, and the control module is configured to compare the identifying information acquired in real time with identifying information of the personnel identity information obtained from the server and determine that the comparing result is a matched comparing result if the acquired identifying information is consistent with the obtained identifying information.

3. The electronic employee card as claimed in claim 1, wherein the identifying information of the holder of the electronic employee card comprises fingerprint information.

4. The electronic employee card as claimed in claim 1, further comprising a display module configured to display the personnel identity information received by the communication module, under the control of the control module.

5. The electronic employee card as claimed in claim 4, further comprising a memory module coupled to the control module and configured to store the personnel identity information received by the communication module, wherein the control module is configured to load the personnel identity information stored in the memory module to the display module.

6. The electronic employee card as claimed in claim 2, wherein:
the server is configured to transmit information of successfully punching a time clock by the holder of the electronic employee card and the personnel identity information to the communication module when the sever obtains the matched comparing result; or
the control module is configured to transmit, via the communication module, the matched comparing result to the server when the control module obtains the matched comparing result, and the server is configured to transmit the information of successfully punching a time clock by the holder of the electronic employee card to the communication module according to the received matched comparing result; and
the control module is configured to transmit a first display instruction to the display module after the communication module receives the information of successfully punching a time clock by the holder of the electronic employee card, so as to control the display module to display the personnel identity information.

7. The electronic employee card as claimed in claim 6, wherein:
the server is configured to transmit information of unsuccessfully punching a time clock by the holder of the electronic employee card to the communication module when the server obtains an unmatched comparing result, or
the control module is configured to transmit, via the communication module, the unmatched comparing result to the server when the control module obtains the unmatched comparing result, and the server is configured to transmit the information of unsuccessfully punching a time clock by the holder of the electronic employee card to the communication module according to the unmatched comparing result received; and
the control module is further configured to transmit a second display instruction to the display module after the communication module receives the information of unsuccessfully punching a time clock by the holder of the electronic employee card, so as to control the display module to display the information of unsuccessfully punching a time clock by the holder of the electronic employee card.

8. The electronic employee card as claimed in claim 6, wherein the control module is further configured to control the display module to display options to be selected by the holder after transmitting the display instruction to the display module;
the electronic employee card further comprises an input module coupled to the control module and configured to input an option selected by the holder to the control module; and
the control module is further configured to control the display module to display the personnel identity information when receiving an option that it is determined to display the personnel identity information.

9. The electronic employee card as claimed in claim 8, wherein the input module comprises a keyboard input module and/or a touch screen input module.

10. The electronic employee card as claimed in claim 1, wherein the control module is further configured to be in data communication with the server through the communication module to obtain at least one of meal card data information, entrance guard data information, notification data information from the server.

11. The electronic employee card as claimed in claim 1, wherein the communication module comprises a wireless communication unit.

12. The electronic employee card as claimed in claim 11, further comprising a wireless signal detecting module configured to detect a wireless signal in a surrounding environment and transmit a trigger signal to the control module when detecting a wireless signal that matches with a preset wireless signal address, and
the control module is further configured to control the communication module to establish a data communication with the server after receiving the trigger signal.

13. The electronic employee card as claimed in claim 1, further comprising a power-supply module configured to supply power to the electronic employee card.

14. The electronic employee card as claimed in claim 13, wherein the power-supply module comprises a battery and a power management unit coupled to each other, and the power management unit is configured to transform electrical energy from the battery to electrical energy that is required for the control module.

15. The electronic employee card as claimed in claim 4, wherein the control module is further configured to receive, through the communication module, a notification transmitted by the server and control the display module to display the notification.

16. The electronic employee card as claimed in claim 5, wherein the control module is configured to receive, through the communication module, a notification transmitted by the server and control the display module to display the notification; and
the control module is further configured to transmit the notification to and store the notification in the memory module.

17. A personnel management system, comprising the electronic employee card as claimed in claim 1 and a server, wherein the server prestores therein the personnel identity information corresponding to the holder of the electronic employee card.

18. A personnel management method using the electronic employee card as claimed in claim 1, the personnel management method comprising:
comparing the identifying information of the holder of the electronic employee card acquired in real time with the prestored personnel identity information;
determining successfully checking on work attendance when the personnel identity information matches with the identifying information of the holder of the electronic employee card; and
determining unsuccessfully checking on work attendance when the personnel identity information does not match with the identifying information of the holder of the electronic employee card.

19. The personnel management method as claimed in claim 18, further comprising:
determining the holder of the electronic employee card leaves earlier than one should if the identifying information of the holder of the electronic employee card is not acquired in a first preset period of time and a beginning time point of the first preset period of time is earlier than an ending time point of a second preset period of time;
wherein the first period of time is smaller than the second period of time.

20. A personnel management method using the personnel management system as claimed in claim 17, the personnel management method comprising:
comparing the identifying information of the holder of the electronic employee card acquired in real time with the prestored personnel identity information;
determining successfully checking on work attendance when the personnel identity information matches with the identifying information of the holder of the electronic employee card; and
determining unsuccessfully checking on work attendance when the personnel identity information does not match with the identifying information of the holder of the electronic employee card.
